(19) United States
(12) Patent Application Publication
(10) Pub. No.: US 2017/0080587 A1
(43) Pub. Date: Mar. 23, 2017

(54) Device for Grooving Material Sheets

(71) Applicant: KOLBUS GMBH & CO. KG, RAHDEN (DE)

(72) Inventors: KLAUS GERKE, BASSUM (DE); JAKOB WARKENTIN, ESPELKAMP (DE); DOMINIK SIMON, DIEPENAU (DE)

(21) Appl. No.: 15/267,557

(22) Filed: Sep. 16, 2016

(30) Foreign Application Priority Data
Sep. 18, 2015 (DE) 10 2015 012 228.2

(51) Int. Cl. B26D 3/06; B26D 7/26; B31B 1/20; B26D 3/10

(52) U.S. Cl. CPC B26D 3/065; B26D 3/10; B26D 7/2628; B31B 1/20; B31B 2201/143; B31B 2203/105

(57) ABSTRACT

In order to simultaneously cut several parallel grooves into material cuttings at a short distance from one another, the groove cutting machine features a horizontally arranged transport drum and at least one groove cutting tool with several knife sets for respectively cutting a groove, wherein the relative position between the knife sets of a groove cutting tool is variable in the axial direction of the transport drum.

### BACKGROUND

The present invention pertains to a device for grooving material sheets.

In order to produce high-quality and stable boxes with little material input, it is common practice to fabricate a multilayer structure consisting of a core made of corrugated board and a relatively thin skin in comparison with the core. If this skin is directly laminated onto the corrugated board core, it frequently occurs that the cover layer slightly sags between the corrugations such that the structure of the corrugated board is visibly and sensibly reproduced on the finished product. This is the reason why the corrugated board core is for high-quality products wrapped with a cover of cardboard or thin solid board, wherein a form-fitting connection or a merely punctiform integral connection between the core and the cover is produced. In this case, the cover encompasses the sidewalls of the core on its outer surfaces and on its inner surfaces, as well as on the edges lying in between. For aesthetic reasons, the visible bending points of the cover, which frequently is elaborately finished, should be realized in a sharp-edged fashion on the finished product.

In a few instances, a support structure in the form of a core is completely eliminated and the box is merely composed of the thin-walled cover forming hollow sidewall elements of the box.

In order to prepare such sharp-edged bending points, triangular grooves are cut into the material cuttings of the cover. The aperture angle between the two groove flanks, which is also referred to as groove angle, as well as the groove depth, is defined by the material thickness, the material and, if applicable, any finishing such as, e.g., a film lamination, as well as the function of the cut groove on the box produced of the cutting, wherein said angle normally lies between 90° and 120°.

A suitable groove cutting machine of this type is known from CN101200091B. The groove cutting tools are mounted in an axially adjustable fashion on carrier beams that lie parallel to the horizontally arranged transport drum and extend between the sidewalls of the machine frame. The tools respectively feature two knives, which are fixed on a knife receptacle obliquely to one another by a fixed angle, as well as board hold-down devices and waste deflectors arranged downstream of the groove cutting tools.

In order to simplify the adjustability of the groove angle, EP2727716A1 proposes a knife receptacle with a curved guide, wherein the curved guide defines a pivoting axis of the knives, which extends parallel to the transport drum and through the cutting tips of the knives, such that a pivoting motion of the knives about this axis only causes a change of the groove angle, but does not affect the groove depth.

In order to ensure a sufficient stability of the groove cutting tools and their mounting in the groove cutting machine for a precise grooving operation, the groove cutting tools are several times wider than the groove to be produced thereby. Consequently, the smallest possible spacing between two grooves produced by groove cutting tools adjacently arranged on the same carrier beam also amounts to several times the desired groove widths. However, the spacing between two adjacent grooves in board cuttings for covers of the initially described boxes significantly falls short of the smallest possible groove spacing attainable with such a groove cutting machine. In order to realize this required small spacing of only a few millimeters between two adjacent grooves, multiple passes of the material sheet through the groove cutting machine are required such that the production effort is significantly increased.

As an alternative to multiple passes through the groove cutting machine, EP2684683A1 proposes the arrangement of additional carrier beams for groove cutting tools, which are arranged parallel to the first carrier beam and offset relative thereto in the transport direction. In addition to a more elaborate construction, a significant disadvantage of this arrangement can be seen in that the accessibility and visibility of the groove cutting region are significantly restricted by the additional carrier beams, as well as in the increased set-up effort.

### SUMMARY

The invention is based on the objective of providing a device of the generally described type, in which the aforementioned disadvantages are eliminated with a simple and cost-efficient construction.

This objective is attained in that the groove cutting tool features at least one second knife set which is fixed on at least one second knife receptacle, and comprises at least one knife for cutting a second groove parallel to the first groove, wherein the relative position between the first knife receptacle and the second knife receptacle is variable in the direction of the axis of the transport drum.

Preferably, the groove cutting machine features a driven transport drum, which is mounted in a frame such that it is rotatable about its horizontally arranged longitudinal axis, as well as hold-down elements, which revolve in an endless fashion and press the material cuttings to be grooved against the outer surface of the transport drum such that they are effectively transported. The groove cutting machine furthermore comprises at least one carrier beam, which extends parallel to the transport drum and on which one or more groove cutting tools are arranged between the hold-down elements. The groove cutting tool comprises two or more knife receptacles, which are respectively equipped with their own set of knives for respectively cutting a groove. In this way, several parallel grooves are simultaneously cut into the board cutting by means of a single cutting tool. In this case, the second knife receptacle can be variably positioned relative to the first knife receptacle of the same groove cutting tool in the axial direction of the transport drum such that the groove cutting tool can be adjusted to different spacings between the grooves simultaneously produced thereby.

In this way, only a small number of carrier beams is required for producing a given number of grooves in the board cutting such that a compact and cost-effective construction of the grooving device is achieved. Furthermore, the number of grooves, which can be simultaneously produced in one pass with conventional grooving devices, can be significantly increased in a very simple fashion by replacing the groove cutting tools with those of the inventive device.

In addition, the device also makes it possible to produce complex groove geometries with simple knives by partially superimposing several grooves, wherein the geometry of said grooves does not change when the position of the groove cutting tool is changed such that position changes of this type can be very easily realized.

It is preferred that the hold-down down elements, which press the board cuttings against the transport drum such that they are effectively transported, are formed by endless belts that revolve around rollers and are looped around the transport drum in the region of the transport path of the cuttings. In this way, the board cuttings are pressed against the outer surface of the transport drum with a spatially and temporally constant force during the entire cutting process and over the entire transport path formed by the transport drum such that a particularly uniform pass and therefore precisely cut grooves are achieved.

In a preferred embodiment, the groove cutting tool features a frame, on which the two or more knife receptacles are arranged. This frame simultaneously forms the receptacle of the groove cutting tool on the carrier beam and thereby allows a compact, yet open and therefore accessible design.

The second knife receptacle of the groove cutting tool preferably features an adjusting device, by means of which the arrangement of the knife sets of the groove cutting tool relative to one another can be varied in order to thereby easily adjust the spacing between the grooves produced by the groove cutting tool.

The aforementioned adjusting device preferably features a linear guide arranged parallel to the drum axis, as well as a clamping element for fixing the second knife receptacle in the adjusted position relative to the first knife receptacle of the same groove cutting tool such that the spacing between the grooves cannot inadvertently change and their parallel alignment is ensured.

In a first alternative embodiment, the adjusting device features a spindle, by means of which the position of the knife receptacle along its linear guide is adjusted, such that the adjustment can be carried out in a particularly simple and comprehensible fashion.

In a second alternative embodiment, the positioning is carried out by means of a cam, which due to its non-linear transmission characteristic makes it possible to easily realize a more sensitive adjustment of small groove spacings, in which positioning errors can be visually detected much easier, than of larger groove spacings, in which deviations are more difficult to detect.

It is preferred that the knife receptacles respectively feature a curved guide, the center of which approximately extends through the knife tips of the respective knife set. In this way, the aperture angle of the groove being produced can be easily adjusted without affecting the groove depth.

In an advantageous enhancement, the knife receptacle comprises an additional adjusting device, which acts radially referred to the transport drum, such that the cutting depth of the respective knife set and therefore the depth of the grooves being cut by this knife set can be adjusted. This makes it particularly simple to produce grooves with different depths in one pass and to compensate different dimensions of the knives as a result of resharpening their blades.

A waste channel is preferably assigned to each knife set and removes the trimmings produced by cutting the grooves such that soiling of the device is significantly reduced, particularly in the region of the tools and transport elements acting upon the board cuttings, and markings of the board cuttings caused by material residues are prevented. A particularly compact design is achieved if a waste channel of the tool is formed by an adjacent knife receptacle of the same groove cutting tool. This makes it possible to reduce the structural space required by the groove cutting tool, as well as the number of its components.

It is advantageous if each knife receptacle additionally comprises a hold-down element, which presses the board cutting against the transport drum in the immediate vicinity of the associated knives, such that the board cutting is in the cutting region prevented from separating from the transport drum due to the cutting forces. The structural space required for the groove cutting tool is reduced if a hold-down element forms the inlet of the waste channel of the adjacent knife receptacle of the same groove cutting tool such that the spacings between the knife sets of a groove cutting tool required by the knife receptacles are reduced.

### BRIEF DESCRIPTION OF THE DRAWING

An exemplary embodiment of the inventive device is described in greater detail below with reference to the drawing, in which:

FIG. 1 shows a board cutting, part of which was folded upright into a hollow-walled box;

FIG. 2 shows a perspective representation of a groove cutting machine;

FIG. 3 shows a perspective representation of a groove cutting tool for producing two parallel grooves; and

FIG. 4 shows a rear view of a groove cutting tool for producing two parallel grooves.

### DETAILED DESCRIPTION

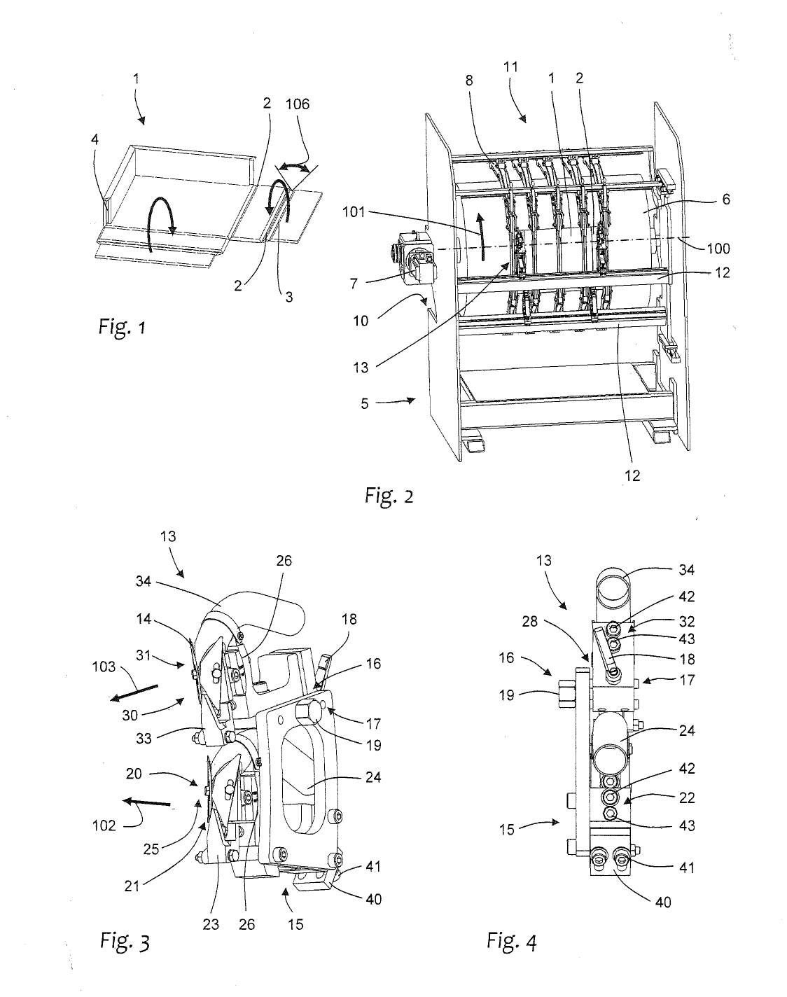

FIG. 1 shows a grooved and partially uprighted board cutting 1 typically used for boxes of the initially described type. This cutting 1 is divided into multiple segments by means of grooves 2, 3 that define bending edges. In this case, all grooves 2, 3 are located on the same side of the board cutting 1 and respectively have an aperture angle 106 of slightly more than 90° between their groove flanks.

The segments located directly adjacent to the central segment forming the bottom of the box form the outer sides of the sidewalls after all segments have been folded upright. These sidewalls respectively feature a hollow space 4 that, if applicable, can accommodate a core of corrugated board for reinforcement purposes and is respectively formed by the segments arranged cruciformly adjacent to the central segment.

According to FIG. 2, the groove cutting machine comprises a horizontally mounted transport drum 6 driven by a geared motor 7, several endless and spaced-apart belts 8, which revolve around rollers 9 and are partially looped around the transport drum 6 such that an inlet 10 and an outlet 11 are formed, as well as groove cutting tools 13 arranged between the belts 8 at a defined spacing from the outer drum surface. Board cuttings 1 fed to the inlet 10 by a not-shown feed device are pressed against the outer drum surface by the belts 8 and thereby effectively transported in the transport direction 101 from the inlet 10 located at the lower vertex of the transport drum 6 to the outlet 11 located at the upper vertex in the form of an approximately 180° rotation of the transport drum 6 and during this process guided past knife sets 21, 31 of the groove cutting tool 13, which respectively cut a V-shaped trimming out of the board cuttings 1.

The belts 8, as well as the groove cutting tools 13, are arranged on carrier beams 12 that extend from one sidewall of the frame 5 to its other sidewall parallel to the drum axis 100 and have the same radial spacing from the transport drum 8, but are arranged behind one another in the transport direction 101.

FIG. 3 and FIG. 4 show the same example of a groove cutting tool 13 of the groove cutting machine illustrated in FIG. 2. It comprises a frame 15 that can be fixed on the carrier beam 12 with a clamping piece 40 that is driven by clamping screws 41. After the clamping piece 40 has been loosened, the groove cutting tool 13 can be axially displaced relative to the transport drum 6 such that the position of the grooves 2, 3 to be cut into the board cutting 1 can be varied. Two functionally identical knife receptacles 20, 30 of the groove cutting tool 13 are arranged on the frame 15.

A first knife receptacle 20 for cutting first grooves 2 features a first knife set 21 mounting two identical knives 14 and is connected to the frame 15 by means of a first adjusting device 22 in such a way that the knife set can be adjusted relative to the frame in the radial direction 102 referred to the transport drum 6. To this end, the first adjusting device 22 comprises a linear guide that is arranged radially referred to the transport drum 6, an adjusting screw 42, as well as an additional screw 43 for fixing the radial position of the first knife set, such that the respective cutting depth is continuously adjustable.

In order to adjust the groove angle 106, the first knife receptacle 20 comprises a curved guide 26 arranged between the first knife set 21 and the first adjusting device 22, wherein the center axis of the curved guide 26 extends through the tips of the knives of the first knife set 21 defining the groove depth such that its angular position relative to the curved guide 26 does not affect the groove depth.

The first knife receptacle 20 comprises a first hold-down element 23, which is spring-loaded against the board cutting 1 being transported on the transport drum 6, upstream of the first knife set 21 referred to the transport direction 101 of the transport drum 6, wherein this first hold-down element ensures that the board cutting 1 is securely pressed against the transport drum 6 in the immediate vicinity of the knives 14 such that a precisely cut first groove 2 is produced.

The first knife receptacle 20 comprises a first waste channel 24 downstream of the first knife set 21, wherein the inlet 25 of this first waste channel extends between the knives 14 of the first knife set 21 such that the trimmings are reliably removed from the cutting and transport region of the board cuttings 1. This first waste channel 24 is realized in the form of a curved tube and therefore can be connected to a waste suction device in a particularly simple fashion.

A second knife receptacle 30 with a second knife set 31 for cutting second grooves 3 is arranged on the frame of the groove cutting tool downstream of the first knife receptacle 20 referred to the transport direction 101, wherein the design of this second knife receptacle is largely identical to that of the first knife receptacle 20. It likewise comprises a second adjusting device 32 of the groove cutting tool 13, which acts in the radial direction 103 referred to the transport drum 6, a curved guide 26 for adjusting the groove angle 106, as well as a spring-loaded second hold-down element 33 and a second waste channel 34 as already described above with reference to the first knife receptacle 20.

In contrast to the first knife receptacle 20, however, the second knife receptacle 30 is connected to the frame 15 of the groove cutting tool 13 by means of an additional adjusting device 16, which also makes it possible to adjust the second knife receptacle 30 parallel to the drum axis 100 and relative to the first knife receptacle 20, such that the spacing between the grooves 2, 3 produced by the first knife set 21 on the one hand and by the second knife set 31 on the other hand can be varied with the aid of this adjusting device 16. For this purpose, the second knife receptacle 31 is mounted in a linear guide 17 arranged parallel to the drum axis 100 such that it can be moved relative to the frame 15 and the first knife set 21 by means of a spindle 19. In order to prevent inadvertent changes of the spacing between the second groove 3 and the first groove 2, the position of the second knife receptacle 30 along the linear guide 17 extending parallel to the drum axis 100 can be fixed by means of a clamping element 18. For example, an adjusting element in the form of a cam can also be used as an alternative to the spindle 19.

In order to realize a fast and precise adjustment of the spacing between the first groove 2 and the second groove 3, the described adjusting device 16 makes it possible to clamp a material sample of the supporting core to be wrapped with the board cutting 1 into the gap formed between the frame 15 of the groove cutting tool and the second knife receptacle 30 in the vicinity of its linear guide 17 such that the groove spacing 28 corresponds to the actual thickness of the material sample.

1. A device for grooving board cuttings, comprising:
a driven transport drum, mounted for rotation about a horizontal axis with a circumferential outer surface;
a plurality of endlessly revolving hold-down elements, which are spaced apart from one another in the direction of the drum axis and press the board cuttings against the outer drum surface such that the board cuttings are effectively transported;
at least one carrier, arranged parallel to the axis of the transport drum;
at least one groove cutting tool, arranged on the carrier and positionable to confront the outer surface of the transport drum between the hold-down elements, wherein said groove cutting tool includes a first knife set fixed on a first knife receptacle with at least one knife, for cutting a first groove;
at least one second knife set on the groove cutting tool, fixed on at least one second knife receptacle with at least one knife, for cutting a second groove parallel to the first groove;
wherein the relative position between the first knife receptacle and the second knife receptacle is variable in the direction of the axis of the transport drum.

2. The device according to claim 1, wherein the hold-down elements are formed by endless and spaced-apart belts, which revolve around rollers and are partially looped around the transport drum such that an inlet and an outlet are formed.

3. The device according to claim 1, wherein the groove cutting tool includes a frame arranged on the carrier and connecting the at least one second knife receptacle to the first knife receptacle.

4. The device according claim 3, wherein the frame includes an adjusting device for varying a position of at least one second knife set relative to the first knife set in the direction of the axis of the transport drum.

5. The device according to claim 1, wherein each knife set defines a groove aperture angle and at least one of the first knife receptacle and a second knife receptacle comprises a curved guide for adjusting the aperture angle of the respective groove.

6. The device according claim 3, wherein at least one of the knife receptacles includes an adjusting device such that said at least one knife receptacle is adjustable relative to the frame of the groove cutting tool in a radial direction relative to the transport drum surface.

7. The device according to claim 4, wherein the adjusting device acting in the axial direction includes at least one linear guide, arranged parallel to the axis of the transport drum, for varying a position of at least one second knife receptacle relative to the first knife receptacle.

8. The device according to claim 4, wherein the adjusting device acting in the axial direction includes at least one clamping element for fixing a position at least one second knife set relative to the first knife set.

9. The device according to claim 4, wherein the adjusting device acting in the axial direction comprises at least one spindle for adjusting a position of at least one second knife receptacle relative to the first knife receptacle in the direction of the axis of the transport drum.

10. The device according to claim 4, wherein the adjusting device acting in the axial direction comprises at least one cam for adjusting a position of at least one second knife receptacle relative to the first knife receptacle in the direction of the axis of the transport drum.

11. The device according to claim 3, wherein
the frame includes an adjusting device for varying a position of one said second knife set relative to the first knife set in the direction of the axis of the transport drum;
the adjusting device acting in the axial direction includes a linear guide, arranged parallel to the axis of the transport drum, for varying a position of a second knife receptacle with said one second knife set relative to the first knife receptacle and thereby varying said position of said one second knife set relative to the first knife set in the direction of the axis of the transport drum; and
at least one of said knife receptacles includes an adjusting device such that said knife receptacle is adjustable relative to the frame of the groove cutting tool in a radial direction relative to the transport drum surface.

12. The device according to claim 1, wherein each knife receptacle has a respective waste channel and the waste channel of the first knife receptacle is at least partially formed by at least one second knife receptacle.

13. The device according to claim 1, wherein a hold-down element, presses the board cutting against the transport drum surface adjacent to a second knife set and forms an inlet of the first waste channel.

14. A device for grooving board cuttings, comprising:
a driven transport drum having an outer surface, rotatably mounted about a horizontal axis;
a plurality of endlessly revolving hold-down elements, which are spaced apart from one another in a direction parallel to the drum axis and press the board cuttings against the outer drum surface such that the cuttings are effectively transported on the rotating drum surface;
at least one tool carrier, arranged parallel to the drum axis;
at least one groove cutting tool arranged on the carrier for positioning toward the outer surface of the drum in a direction transverse to the drum axis, between the hold-down elements;
wherein each groove cutting tool includes a first knife set fixed on a first knife receptacle with a first knife, for cutting a first groove;
a second knife set fixed on a second knife receptacle with a second knife for cutting a second groove parallel to the first groove; and
mounts for the first and second knife receptacles such that a relative operating position between the first knife receptacle and the second knife receptacle is variable in a direction parallel to the drum axis.

15. The device according to claim 14, wherein the groove cutting tool includes a frame, arranged on the carrier and connecting the at least one second knife receptacle to the first knife receptacle; and the frame includes an adjusting device for varying a position a second knife set relative to the first knife set in the direction of the axis of the transport drum.

16. The device of claim 15, wherein each knife set defines a groove aperture angle and at least one of the first knife receptacle and said second knife receptacle comprises a curved guide for adjusting the aperture angle of the respective groove.

17. The device according claim 16, wherein at least one of the knife receptacles includes an adjusting device such that said at least one knife receptacle is adjustable relative to the frame of the groove cutting tool in a radial direction relative to the transport drum surface.
